(19) United States
(12) Patent Application Publication
(10) Pub. No.: US 2015/0194040 A1
(43) Pub. Date: Jul. 9, 2015

(54) INTELLIGENT MOTION SENSOR

(71) Applicant: Fibar Group sp. z o.o., Poznan (PL)

(72) Inventors: Maciej Fiedler, Poznan (PL); Bartlomiej Arcichowski, Poznan (PL); Robert Zdunek, Wrzesnia (PL)

(21) Appl. No.: 14/590,988

(22) Filed: Jan. 6, 2015

Related U.S. Application Data
(60) Provisional application No. 61/924,205, filed on Jan. 6, 2014.

(51) Int. Cl. G08B 21/18; H04Q 9/00; H04W 4/00

(52) U.S. Cl. CPC G08B 21/182; H04W 4/005; H04Q 9/00

(57) ABSTRACT

An intelligent sensing device including a temperature sensor to detect a temperature proximate the intelligent sensing device, an optical sensor to detect a presence of one or more objects, a controller to receive the temperature and the presence of the one or more object, to determine if the received temperature exceeds a temperature threshold, and to track a number of the one or more objects, and an indicator to generate an alarm responsive to one of 1) the received temperature exceeding the temperature threshold and 2) the number not matching a number threshold.

### CLAIM OF PRIORITY/INCORPORATION BY REFERENCE

This patent application makes reference to, claims priority to and claims benefit from U.S. Provisional Patent Application Ser. No. 61/924,205 entitled “Intelligent Motion Sensor” filed on Jan. 6, 2014, which is hereby incorporated herein by reference in its entirety.

### TECHNICAL FIELD

Aspects of the present disclosure relate to electronic systems and/or networking. More specifically, certain implementations of the present disclosure relate to an intelligent motion sensor.

### BACKGROUND

Existing methods and systems for providing device monitoring or control can be costly, cumbersome and inefficient. Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for an intelligent motion sensor, substantially as shown in and/or described in connection with at least one of the figures, as set forth more completely in the disclosure and/or the claims.

These and other advantages, aspects and novel features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 illustrates an example home network.

FIG. 2 illustrates an example intelligent motion sensor.

FIG. 3 illustrates an example flow chart of a method for an example process of operation of an intelligent motion sensor.

FIG. 4 illustrates an example intelligent motion sensing control system.

### DETAILED DESCRIPTION

Certain implementations may be found in a method and system for an intelligent motion sensor. In one embodiment, the disclosure may provide an intelligent sensing device including a temperature sensor to detect a temperature proximate the intelligent sensing device, a motion sensor to detect a presence of one or more objects, a controller to receive the temperature and/or the presence of the one or more object, to determine if the received temperature exceeds a temperature threshold, and/or to track a number of the one or more objects, and an indicator to generate an alarm responsive to one of 1) the received temperature exceeding the temperature threshold and 2) the number not matching a number threshold.

In one embodiment, the disclosure may provide a control system for use with a sensing device in a wireless network. The control system may include a control device to perform a predefined action. The control system may also include an intelligent sensing device that may further include a temperature sensor to detect a temperature proximate the intelligent sensing device, a motion sensor to detect a presence of one or more objects, and/or a controller to receive the temperature and the presence of the one or more object, to determine if the received temperature exceeds a temperature threshold, and to track a number of the one or more objects. The intelligent sensing device may also include an indicator to generate an indication responsive to one of 1) the received temperature exceeding the temperature threshold and 2) the number not matching a number threshold, and/or a transceiver to communicate the indication. The control system may also include a network manager, being remote from the intelligent sensing device and the control device, wirelessly coupled to the intelligent sensing device and the control device through the wireless network, and/or to receive the indication from the intelligent sensing device, and, in response to having received the indication, to perform the predefined action.

In one embodiment, the disclosure may provide a method of controlling a network device operable to perform a function in a network via a) an intelligent sensing device, and being remote from the network device, and/or b) a network manager operable to communicate with the network device and the intelligent sensing device. The method may include detecting at the intelligent sensing device a temperature proximate the intelligent sensing device, detecting at the intelligent sensing device a presence of one or more objects, and/or determining if the temperature exceeds a temperature threshold. The method may also include tracking a number of the one or more objects, and/or generating an indication responsive to one of 1) the temperature exceeding the temperature threshold and 2) the number not matching a number threshold.

As utilized herein the terms “circuits” and “circuitry” refer to physical electronic components (i.e. hardware) and any software and/or firmware (“code”) which may configure the hardware, be executed by the hardware, and/or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and/or “module” refer to functions than may be performed by one or more circuits. As utilized herein, the term “example” means serving as a non-limiting example, instance, or illustration. As utilized herein, the terms “for example” and “e.g.” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

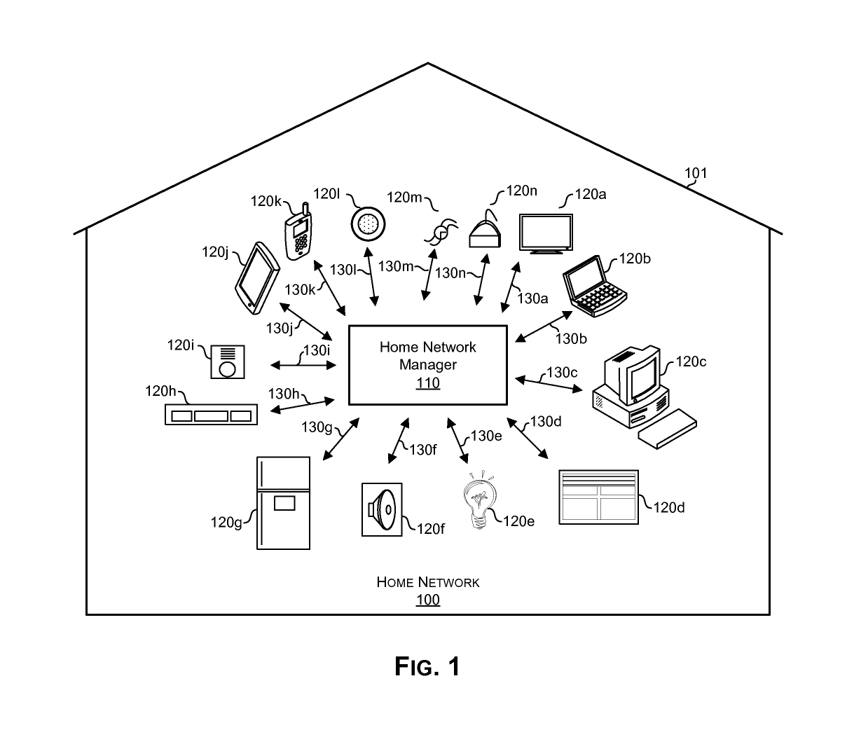

FIG. 1 illustrates an example home network. Referring to FIG. 1, there is shown a home network 100.

The home network 100 may correspond to a location 101. The location 101 may, for example, correspond to a residence (e.g., home, apartment) or non-residence premises (e.g., small business, school, library, factory, etc.). In this regard, the home network 100 may, for example, comprise a plurality of home network elements, such as, for example, a plurality of home network elements 120a-120n. The home network elements (e.g., home network elements 120a-120n) may, for example, comprise one or more devices, systems, fixtures, appliances, and/or other circuitry. The home network elements (e.g., home network elements 120a-120n) may comprise, for example, one or more televisions 120a, one or more computers (e.g., laptop computer 120b, desktop computer 120c), one or more personal and/or handheld devices (e.g., tablet 120j, mobile phone 120k, smart watch 120m), one or more multimedia devices and/or components (e.g., speakers 120f), one or more structural fixtures (e.g., windows/window blinds 120d), one or more lighting and/or electrical fixtures 120e, one or more appliances (e.g., refrigerator 120g), one or more environmental sensory devices 120h (e.g., thermometers, humidity meters), one or more security devices 120i (e.g., a smoke detector, a carbon monoxide detector, a security alarm, a motion detector), one or more sensors and/or controllers (e.g., intelligent motion sensor 120l, RGBW controller 120n) and/or other devices.

The disclosure is not limited to any particular type of a home network. Furthermore, the disclosure is not limited to any particular combination of home network elements. It is to be understood that although the network is referred to as a “home network” throughout the disclosure, the disclosure is not limited in this way. Specifically, the network may comprise any other network that may be operable to control one or more network elements. For example, the network of the disclosure (whether or not referred to as a “home network”) may be implemented in a residential, non-residential, commercial, industrial and/or any other setting. Similarly, the network elements may comprise network elements (whether or not referred to as a “home network elements”) implemented in a residential, non-residential, commercial, industrial and/or any other setting.

In some instances, the home network 100 may incorporate a home network manager 110. The home network manager 110 may comprise suitable circuitry, interfaces, logic, and/or code for implementing various aspects of the present disclosure. For example, the home network manager 110 may be configured for use in managing, servicing, and/or interacting with one or more home network elements. Although the home network manager 110 is shown in FIG. 1 as a single and separate device, the disclosure is not limited in this way. For example, in some implementations, one or more functions of the home network manager 110 may be provided by one or more home network elements (e.g., providing user interface via tablet 120j and/or television 120a). In an example embodiment of the disclosure, the home network manager 110 may be implemented as a virtual platform, such as, for example, one or more software modules may run on, and/or utilize resources of one or more home network elements (e.g., laptop 120b, desktop 120c).

The home network manager 110 may be configured to communicate with one or more elements (e.g., home network devices, home network elements) in a home network. In an example embodiment of the disclosure, the home network manager 110 may be operable to communicate with one or more devices and/or systems that may be external to a home network, using, for example, optical, wired and/or wireless communication links.

Although the home network manager 110 is illustrated as a single device, the disclosure is not limited in this way. For example, the home network manager may comprise one or more home network manager that may each interact with one or more home network elements (e.g., home network elements 120a-120n). In an example embodiment of the disclosure, each of the one or more home network managers may be associated with particular one or more home network elements. In another example, one or more of the one or more home network managers may be associated with any one or more home network elements (e.g., home network elements within range of a particular home network manager, with best communication path).

In an example embodiment of the disclosure, the home network manager 110 may be implemented in an integrated or a distributed system. An integrated system may be implemented, for example, on one computer, server, machine or device, where the integrated system may be configured to perform some or all of the functions, features and/or operations of the home network manager 110 as described herein. A distributed system may be implemented with multiple components (e.g., computers, servers, machines and/or devices), where each of the multiple components may be configured to perform some or all of the functions, features and/or operations of the home network manager 110 as described herein. Each function, feature and/or operation may be implemented on one or more of the components of the distributed system. For example, a specific feature, function and/or operation may be implemented only one component of the distributed system or it may be implemented across multiple components of the distributed system.

In an example embodiment of the disclosure, in addition to or instead of the use of one or more home network managers, the home network 100 may comprise one or more master controllers for controlling one or more home network elements. A master controller may be pre-programmed and/or programmable to control one or more home network elements. A master controller may comprise, for example, a remote controller.

Although the disclosure may refer to a single home network manager, it is to be understood that the disclosure is not limited in this way. For example, the home network manager may comprise one or more home network managers that individually and/or in the aggregate may be implemented as integrated and/or a distributed system.

The home network manager 110 may interact with one or more of the home network elements 120a-120n via corresponding links 130a-130n, which may be supported by the home network manager 110 and/or the corresponding home network element(s). For example, the links 130a-130n may be implemented and/or configured to operate using a wireless protocol, such as, for example, a Z-wave protocol. In an example embodiment of the disclosure, the home network 100 may be implemented as Z-Wave network. However, the disclosure is not limited in this way. For example, the home network 110 may comprise one or more wired and/or wireless links and/or protocol. Wireless links and/or protocols, may comprise, for example, WPAN (e.g., Bluetooth or ZigBee), low power links (e.g., Bluetooth LE (BLE), Bluetooth Smart, iBeacon), near field communication protocols (e.g., NFC) and/or WLAN (WiFi/802.11) protocols and/or any other wireless links and/or protocols suitable for implementation consistent with the disclosure. Wired protocols and/or links may comprise, for example, Ethernet, Universal Serial Bus (USB), and/or any other wired links and/or protocols suitable for implementation consistent with the disclosure.

In an example embodiment of the disclosure, home network manager 110 may interact with one or more home network elements (e.g., home network elements) directly and/or indirectly. For example, the home network manager 110 may interact with one or more home network elements directly through a corresponding link (e.g., wireless, wired link/connection).

In another example, the home network manager 110 may interact with one or more home network elements indirectly though, for example, a converter (e.g., global cache.) In this regard, the home network manager 110 that supports one or more particular network interfaces and/or other interfaces (e.g., USB) may be operable to interact with a particular network element (and/or another device) that may otherwise be incompatible with one or more of the one or more particular network and/or other interfaces supported by the home network manger 110. The interaction may be achieved though, for example, a converter and/or a translator. The converter and/or the translator may each comprise suitable logic, circuitry, interfaces, and/or code that may be operable to facilitate communication between a home network manager (e.g., the home network manger 110) and a home network element (home network elements 120a-120n).

In another example, the home network manager 110 may interact with one or more home network elements indirectly though, for example, other network elements. In this regard, the home network manager 110 may interact with one or more home network elements on, for example, a mesh network. An example mesh network (not shown) may facilitate communication (e.g., transmission of messages, signals, data frames) to and/or from the home network manager (e.g., the home network manager 110) to and/or from a particular network element where the communication may, for example, pass through one or more other network elements before reaching the particular network element and/or the home network manager.

In an example embodiment of the disclosure, the home network manager 110 may be operable to support one or more communication methods from one or more other home network devices (e.g., home network elements 120a-120n). For example, one or more home network elements may communicate with the home network manager 110 utilizing a particular wireless link and/or protocol (e.g., Z-wave) and/or a particular wired link and/or protocol (e.g., Ethernet), while one or more other home network elements may communicate with the home network manager 110 utilizing a different particular wireless link and/or protocol (e.g., WiFi) and/or a different particular wired link and/or protocol (e.g., USB).

In an example embodiment of the disclosure, the same one or more home network elements may communicate with the home network manager 110 by, for example, using one or more wired and/or wireless links and/or protocols at the same and/or at different times. For example, a particular network element may communicate with the home network manager 110 using a Z-Wave communication protocol for a particular communication and may communicate with the home network manager 110 using a WiFi communication protocol for another particular communication.

In an example embodiment of the disclosure, one or more home network elements (e.g., home network elements 120a-120n) may communicate with one or more home network elements (e.g., home network elements 120a-120n) directly. In this regard, the one or more network elements may utilize one or more communication links (e.g., wireless, wired) (not shown) and/or one or more network interfaces and/or other interfaces without directing (e.g., routing the communication thought, for example, a home network manager (e.g., the home network manger 110). For example, a home network element may be operable to detect existence of one or more other network elements (e.g., on the same and/or different network) and may initiate, send and/or receive communication to and/or from the one or more other network elements.

In an example embodiment of the disclosure, one network element may be out of range of a home network manager and may communicate with one or more other network elements to determine whether the one or more other network elements are within range of a particular (e.g., a home network manager previously within range of the one network element) and/or any network manager. The range detection and/or discovery may continue from one network element to another. For example, a particular home network element may need to communicate through more than one other home network element in order to, for example, communicate with a desired home network element and/or a desired, particular and/or any home network manager (e.g., the home network manager 110). The disclosure is not limited to a communication for a purpose of range discovery/detection. The communication may comprise any type of communication and may be used for a variety of other purposes (e.g., communicating with a different network element, communicating with a home network manager, controlling an out of range device, controlling another network element).

In an example embodiment of the disclosure, one or more home network elements (e.g., home networks elements 120a-120n) may be operable to control one or more other home network elements (e.g., home networks elements 120a-120n) with and/or without intermediary, such as, for example, a home network manager (e.g., home network manager). For example, one or more home network elements may be operable to control one or more other home network elements through an intermediary. In this regard, a particular network element may communicate with an intermediary (e.g., home network manager) in order to communicate with and/or to control another home networks element. An intermediary may comprise one or more devices (e.g., a preprogrammed and/or programmable master controller, home network manager) that may be operable to control one or more network elements. In another example, a particular network element may directly communicate with and/or to control another home network element.

In an example embodiment of the disclosure, one or more home network elements (e.g. home network elements 120a-120n) and/or other devices that may be operable to communicate on the network (and/or an associated network as described herewith) and/or that may not be operable to communicate on the network but may otherwise be tractable (e.g., GPS, iBeacon, electronic tag), with one or more other network elements, devices and/or a network manager (e.g., home network manager 110) associated with a particular network (e.g., home network 100) (and/or an associated network as described herewith), may communicate with each other, other devices (e.g., on the same network, another network and/or otherwise connected and/or tractable) and/or the network manager, and/or may be operable to determine a precise location of a particular network element, device and/or network manager utilizing various communication protocols and/or interfaces.

For example, one or more network elements (and/or other devices operable on the network, an associated network as described herewith and/or otherwise traceable) may be operable to generate and/or receive information and/or one more signals and/or messages that may be utilized in determining a location of a particular network element, device and/or network manager. In this regard, a near field communication and/or a low power interface protocol (e.g., BLE, iBeacon) may be utilized for communication between the elements, devices and/or network managers. Furthermore, one more tags (e.g., small electronic devices) may be utilized, to facilitate location of particular elements, devices and/or network managers. For example, a network element, device and/or home network manager may generate a signal and/or a message (on the network, on an associated network and/or through a built in, external, portable and/or otherwise attachable tag) that may be received by another network element, device and/or network manager.

In an example embodiment of the disclosure, one or more home network elements, devices and/or manager may cooperate (e.g., exchange information) to, for example, collectively and/or individually determine a precise location of a particular network elements, device and/or network manager based on the received one or more signals and/or messages. As an example only, a particular network element, device and/or home network manager may generate a signal and/or a message that may be received by other network element, device and/or home network device within a particular time frame. The information about the time it took to, for example, receive the particular one or more signals and/or messages (and/or the information gather from the one or more signals and/or messages, such as, for example, signal strength) may be used to determine the precise location (e.g., distance to/from the network element, device, network manager that received the particular one or more signals and/or message) of the particular network element, device and/or network manager.

In operation, the home network manager 110 may be operable to manage a home network (e.g., the home network 100). The home network manager 110 may be utilized, for example, as an interface platform for interacting with various network elements (e.g., the home network elements 120a-120n). In this regard, the home network manager 110 may support establishing and/or configuring one or more communication connections/links (e.g., the links 130a-130n) with the one or more elements of the home network 110. Once established, the connectivity between the home network manager 110 and the home network elements (e.g., elements 120a-120n) may, for example, be utilized to enable centralized monitoring, control, and/or management of the home network elements, and/or of the home network 100 as a whole. For example, the home network manager 110 may be operable to control operations of certain elements (e.g., turn on television 120a, switch to particular channel(s) at particular days/times, and/or record if recording is supported); monitor environment in the home network, such as by obtaining environmental readings (e.g., temperature, humidity, etc.) via example environmental sensory devices 120h, and may process these readings (e.g., to determine if/when to adjust other home network elements accordingly); adjust one or more example lighting and/or electrical fixtures 120e (e.g., turn lights on or off); lower/raise example window (blinds) 120d; adjust operations of example appliances (e.g., refrigerator 120g), such as, for example, based on a preconfigured power efficiency/optimization profile; monitor for any indications of a security/safety problem, based on, for example, input from example security devices 120i, and/or act accordingly (e.g., send notifications to users, such as by texting example smartphone 120k, and/or automatically notify authorities, e.g., by dialing ‘911’ and/or contacting preconfigured emergency numbers).

In an example embodiment of the disclosure, the home network manager 110 may provide and/or utilize user interface services in the home network. In this regard, the home network manager 110 may be operable to support use of user interface functions, and/or to generate and/or store information corresponding thereto, which may be utilized to enable interactions between the home network manager 110 and users (e.g., in the home network 100). For example, in some implementations, the home network manager 110 may be configured to generate and/or use a graphic user interface (GUI), for visually displaying information and/or providing interactivity with users (e.g., for providing input thereby). One or more user interfaces may enable configuring the home network manager 110 and/or functions provided by the home network manager 110. In an example embodiment of the disclosure, the one or more user interfaces may enable user interaction with, configuring and/or adjusting other elements in the home network 100 (e.g., elements connected to the home network manager 110).

In an example embodiment of the disclosure, the user interfaces may be provided via one or more other devices that may be communicatively coupled to the home network manager 110. For example, a GUI generated and/or used by the home network manager 110 may be displayed using existing home network elements, such as, for example, television 120a, laptop 120b, tablet 120j, and/or smartphone 120k.

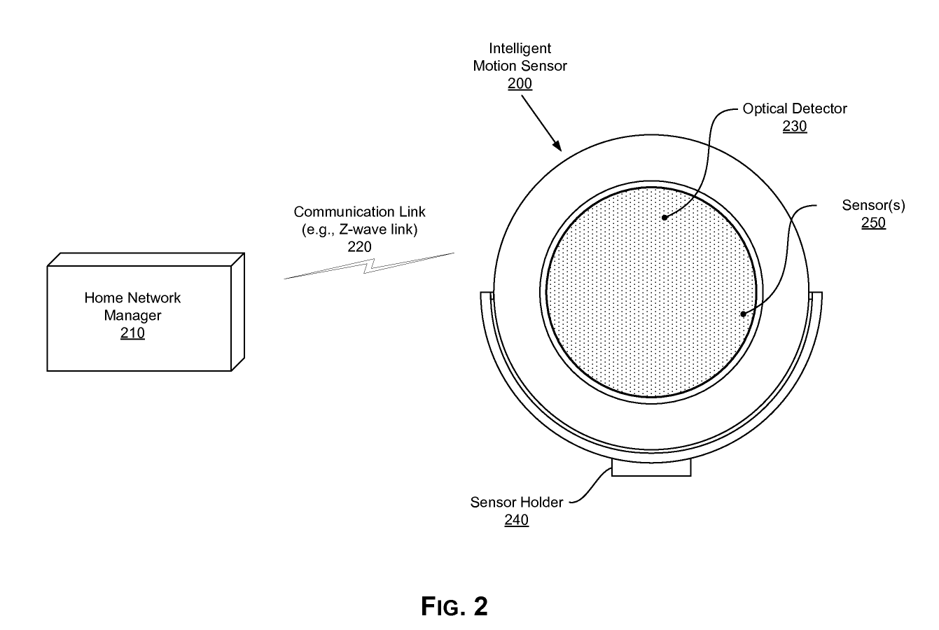

In an example embodiment of the disclosure, the home network 100 (and various components thereof, particularly the home network manager 110) may be configured to support use of intelligent motion sensors (e.g., the intelligent motion sensor 120l). In this regard, an intelligent motion sensor may be configured to provide enhanced motion sensory, as well as additional services or functions, in home networks (e.g., the home network 100) which may not be available in legacy motion sensors. An example intelligent motion sensor is depicted in and/or described with respect to FIG. 2.

The disclosure is not limited to a single network (e.g., home network 100) and/or a single network manager (e.g., home network manager 110). For example, one or more networks (e.g., home network 100) and/or one or more network managers (e.g., home network manager 110) may be grouped together. The grouping may correspond to one or more locations (e.g., location 101).

In an example embodiment of the disclosure, a network (e.g., home network 100) may be associated with one or more network managers (e.g., home network manager 110). For example, one network manager may be associated with one or more networks (e.g., home network 100) and/or locations (e.g., location 101),

In an example embodiment of the disclosure, a grouping of networks may comprise one or more network, network managers and/or locations. The grouping may be programmable and/or configurable. For example, one more networks may be defined, one or more network managers may be assigned per network and/or associated with one or more devices with a network and/or a network manager. In this regard, the information may be shared between the different networks, network managers and/or devices assigned to the different networks and/or network managers. For example, information gathered on one network (e.g., by a network device, through an occurrence of a condition, event, an alarm, and/or other predefined and/or preconfigured condition) may cause the information to be communicated on the same and/or another associated network. In this regard, the information may trigger a condition, an alarm, an occurrence of an event and/or any other predefined and/or preconfigured condition (e.g., operation of a device, network element) on the same and/or another associated network.

FIG. 2 illustrates an example intelligent motion sensor. Referring to FIG. 2, there is shown an intelligent motion sensor 200 and a home network manager 210.

The intelligent motion sensor 200 may comprise suitable circuitry, interfaces, logic, and/or code for implementing various aspects of the present disclosure. In particular, the intelligent motion sensor 200 may be designed, implemented, and/or configured to provide enhanced motion sensory functions, as well as additional services and/or functions which may be used in conjunction with motion sensory functions. Further, the intelligent motion sensor 200 may be configured for operation in home networks, such as the home network 100 described in FIG. 1. Thus, the intelligent motion sensor 200 may be configured for use as a home network element.

Thus, the intelligent motion sensor 200 may be configured to interact with a home network manager of the home network (e.g., the home network manager 210). In this regard, the home network manager 210 may be substantially similar to the home network manager 110 as depicted in and/or described with respect to FIG. 1. For example, the intelligent motion sensor 200 may be configured to interact with the home network manager 210 (and/or other devices) via a communication link 220. The communication link 220 may, for example, comprise a Z-Wave link. The disclosure is not limited to any particular type of a communication link. For example, the intelligent motion sensor 200 may be implemented to support, for example one or more wireless and/or wired links, protocols and/or connections. For example, wireless links, protocols and/or connections, may comprise, for example, WPAN (e.g., Bluetooth or ZigBee), low power links (e.g., Bluetooth LE (BLE), Bluetooth Smart, iBeacon), near field communication protocols (e.g., NFC) and/or WLAN (WiFi/802.11) protocols and/or any other wireless links, protocols and/or connections suitable for implementation consistent with the disclosure. Wired links, protocols and/or connections may comprise, for example, Ethernet, Universal Serial Bus (USB), and/or any other wired links, protocols and/or connections suitable for implementation consistent with the disclosure. While not shown in FIG. 2, to support communication with other elements or systems, such as the home network manager 210, the intelligent motion sensor 200 may incorporate a communication transceiver (e.g., a Z-Wave transceiver) and/or related processing resources for allowing use of the intelligent motion sensor 200.

Further, in some instances the intelligent motion sensor 200 may be operable to interact with other devices (i.e. beside the home network managers) in the home network, such as other home network elements (e.g., one or more of the home network elements 120a-120n of FIG. 1) and/or other intelligent motion sensors. In this regard, the intelligent motion sensor 200 may be configured to interact with the other devices (home network elements) via corresponding communication links, which may each be similar to the communication link 220. In one particular example use scenario, a plurality of the intelligent motion sensor 200 may be deployed in a single location (e.g., a residence) to provide motion detection (and services or functions based thereon) throughout the location. In this regard, the plurality of the intelligent motion sensors 200 may be configured to communicate with one another, such as to coordinate motion detection operations and/or to exchange information related thereto.

The communication by the intelligent motion sensor 200 may be direct and/or indirect. In this regard, the intelligent motion sensor 200 may communicate with a particular peer device (e.g., the home network manager 210, another home network element, or another intelligent motion sensor) directly—i.e., with the link(s) established directly by (and between) the intelligent motion sensor 200 and the peer device. In some instances, however, the communication may be done in indirect manner—e.g., whereby one or more intermediary devices (e.g., network elements, other intelligent motion sensors, home network managers, and/or master controllers) may be used in setting up communication and/or in forwarding data between the intelligent motion sensor 200 and an intended peer device. Thus, in one example embodiment of the disclosure, one or more intermediary devices may be involved in the initial configuration and establishing of the communication between the intelligent motion sensor 200 and the intended peer device. In another example, the communication itself may be indirect—i.e., one or more intermediary devices may be part of the communication path, thus the data would have to traverse these devices when communicated between the intelligent motion sensor 200 and the intended peer device.

In an example embodiment of the disclosure, the intelligent motion sensor 200 may provide wired and/or wireless interfaces that may enable one or more network devices to connect to a home network (e.g., the home network 100) and/or home network manager (e.g., home network manager 210). For example, if the network manager provides connectivity of various devices to a home network, for example, based on a Z-Wave protocol, the intelligent motion sensor 200 may, for example, contain suitable circuitry, interfaces, logic, and/or code that may enable a particular device that, for example, may not be compatible with the example Z-Wave protocol (and/or any other particular protocol that the network manager supports) to connect to the network manager and/or the home network.

The intelligent motion sensor 200 may be configured to perform motion sensory functions based on one or more types of motion sensory techniques—e.g., based on infrared, ultrasonic microwave, tomographic and/or other motion detection techniques. The intelligent motion sensor 200 may also be configured to perform motion sensory detection using other types of motion sensory techniques (including motion sensory detection types which may not have been previously utilized).

In an example embodiment of the disclosure, the intelligent motion sensor 200 may be operable to perform motion sensory based on, for example, optical detection. For example, the intelligent motion sensor 200 may comprise an optical detector 230. The optical detector 230 may be operable to optically scan (including in limited or low visibility conditions, including in the dark) particular portion of the (e.g., three-dimensional) area around the intelligent motion sensor 200 (such as the space that can be covered by the scanning component—e.g., a lens—of the optical detector 230). The optical data obtained by the optical detector 230 in this manner may be used, independently and/or in combination with other motion sensory data (e.g., ultrasonic based data) to enable detection when there is motion in proximity to the intelligent motion sensor 200.

In some instances, the motion detection performed in the intelligent motion sensor 200 may be refined to provide, based on the optical data, more information (i.e. beyond simply determining when/if there is motion; rather, it may allow for more specific information about the object(s) causing the detected ‘motion.’ For example, processing the optical sensory data may incorporate use of recognition techniques (e.g., object recognition and/or facial recognition), to enable determining type of object, or even identity of person (when the object causing the motion is a person). Accordingly, the intelligent motion sensor 200 may be operable to distinguish between person and other, non-human objects that may be triggering the motion detection (e.g., pets); to track the number of persons entering a particular place (e.g., a residence, such as by installing one or more of the intelligent motion sensor 200 at all entrances to the residence); and/or to distinguish between recognized/known persons (e.g., pre-defined, authorized users in the home network) and unknown persons (e.g., possible intruders).

In some instances, the ability to identify the particular person whose motion may be detected may be used to monitor the particular person. This may be used to enable tracking presence of the particular person in different locations (e.g., different rooms in a residence), such as to assess possible activities thereby. For example, a plurality of the intelligent motion sensor 200 may be placed in different rooms of a residence, and these sensors may be used to track the amount time (e.g., based on detecting of motion, particular when entering and exiting the rooms) that a housekeeper (e.g., which may be identified by application of facial recognition to obtained optical data) spends in each room.

In an example embodiment of the disclosure, the intelligent motion sensor 200 may collect, store and communicate date relating to the number of persons that either enter and/or leave a particular location. In this regard, the intelligent motion sensor 200 may be operable to implement (e.g., in addition and/or instead of optical recognition techniques) techniques based on, for example, the number of times, for example, a front door was opened and the motion attributable to a person was detected. In an example embodiment of the disclosure, the intelligent motion sensor 200 may rely on the count to determine the number of people in and out of the particular location (in addition to current motion sensory features).

In an example embodiment of the disclosure, the intelligent motion sensor 200 may be operable to detect and/or obtain other/additional sensory information, which may be used, at least in some instances, in conjunction with the motion sensory data, to further enhance operations of the intelligent motion sensor 200. For example, the intelligent motion sensor 200 may be configured as multi-sensor (e.g., by comprising suitable circuitry and/or components), providing sensory of such additional conditions as temperature, light, etc.

For example, the intelligent motion sensor 200 may comprise one or more sensor(s) 250. The one or more sensor(s) 250 may comprise, for example, an accelerometer (not shown), a temperature sensor (not shown), and/or a light sensor (not shown). In this regard, the accelerometer may be used to, for example, detect movement and/or positioning of the intelligent motion sensor 200 (itself). The accelerometer may be operatively connected to the intelligent motion sensor 200 as, for example, an external device and/or may be integrated with the intelligent motion sensor 200. The intelligent motion sensor 200 may be configured such that at least some of the functions or operations performed by the intelligent motion sensor 200 (e.g., generation of status and/or alarm messages) may be based on the input from the accelerometer.

In an example embodiment of the disclosure, the intelligent motion sensor 200 may be operable to receive data and/or information from the accelerometer that may comprise, for example, information relating to whether the intelligent motion sensor 200 was moved (e.g., titled, moved to a different location), the scope and/or degree of movement (e.g., the intelligent motion sensor was moved by a particular number of degrees with respect to an axis in a 3D plane).

In an example embodiment of the disclosure, the intelligent motion sensor 200 may utilize the data and/or information received from the accelerometer (e.g., with and/or without cooperation with other network elements, devices and/or network managers) to determine whether there is/was an earthquake. In this regard, the intelligent motion sensor 200 may generate an alarm condition (and/or trigger other events and/or scenes) on the same and/or a different (e.g., associated network).

The temperature sensor may be operatively connected to the intelligent motion sensor 200 as, for example, an external device and/or may be integrated with the intelligent motion sensor 200. The intelligent motion sensor 200 may be configured such that at least some of the functions or operations performed by the intelligent motion sensor 200 (e.g., generation of status and/or alarm messages) may be based on the input from the temperature sensor. For example, in one particular use scenario, the intelligent motion sensor 200 may be configured to convey indication of detected ambient information. For example, the optical detector 230 may be implemented as an eye-like interface, with the background color of the ‘eye’ (e.g., implemented as iris-like) being changed based on different temperature ranges—e.g., green for ‘pleasant’ range (e.g., 20-28° C.); blue for ‘cold’ range (e.g., <20° C.); and red for ‘hot’ range (e.g., >28° C.). In some instances, the ranges may be adjustable (e.g., based on user input, in accordance with preferences thereof).

In an example embodiment of the disclosure, the background color of the eye-like intelligent motion sensor 200 may be preprogrammed and/or preconfigured based on one or more criteria. The criteria may, for example, include information and/or data directly obtained by the intelligent motion sensor 200 (e.g., from the optical detector 230, sensor(s) 250, sensor holder 240). For example, the changes in the color of the eye-like intelligent motion sensor 200 may be triggered by changes in temperature, motion and/or other criteria. In another example, the criteria may include, for example, information and/or date received from other network elements, devices and/or home network managers. For example, the changes in the color of the eye-like intelligent motion sensor 200 may be based on an alarm condition, scene activation, etc.

The adjustments of the color of the eye-like intelligent motion sensor 200 may comprise adjustments in the actual color (e.g., green, red, pink, yellow), color intensity, color brightness and/or illumination schemes (e.g., blinking).

The light sensor may comprise an illuminance detector, and may be operatively connected to the intelligent motion sensor 200 as, for example, an external device and/or may be integrated with the intelligent motion sensor 200. The intelligent motion sensor 200 may be configured such that at least some of the functions or operations performed by the intelligent motion sensor 200 (e.g., generation of status and/or alarm messages) may be based on the input from the light sensors. For example, in one particular use scenario, the intelligent motion sensor 200 may be configured to measure using the light detector ambient illuminance (in lx) in proximity of particular users. The measurement may then be used, such as to control lighting fixtures or other light emitting devices (e.g., desk lamp) nearby, such as to increase or decrease the illuminance. In this regard, the adjustment may be aimed at achieving preset ‘preferred’ lighting setting for the particular users.

The disclosure is not limited to a particular combination of sensors (e.g., sensor(s) 250) that the intelligent motion sensor 200 may comprise. It is to be understood that the intelligent motion sensor 200 may comprise one or more various sensors.

In an example embodiment of the disclosure, the intelligent motion sensor 200 may operate and/or communicate with other network elements, devices and/or network managers in response to information and/or data received (proceed or unprocessed) based on the input from various sensors (e.g., optical detector 230, sensor(s) 250). For example, the intelligent motion sensor 200 may trigger a scene and/or an alarm condition when a preconfigured and/or a predefined condition occur (on the same network and/or on an associated network). For example, the intelligent motion sensor 200 may activate “Left for Work” scene (e.g., adjust temperature, close roller blinds, activate burglary alarm) at a home location (e.g., associated with a home network). The intelligent motion sensor 200 may also, in addition to and/or instead of triggering a scene at the same location the intelligent motion sensor 200 is located within and/or with which it is associated (e.g., on the same network), may activate a scene at another location (e.g., same and/or different network). For example the intelligent motion sensor 200 may activate an “Almost at Work” scene (e.g., adjust temperature, turn on lights, open roller blades) at a different location (e.g., associated with an office network.

The present disclosure is not limited in the number and/or the type of different locations, networks, scenes and/or devices and/or network elements that may be involved in a particular trigger/activation and/or scene that the intelligent motion sensor 200 may support. It is to be understood that one or more locations, networks, scenes, devices and/or network elements may be programmed and/or configured depending on a desired outcome.

In some example embodiments, the intelligent motion sensor 200 may be designed, implemented, and/or configured particularly to allow and/or enhance mobility and ease of deployment. For example, the intelligent motion sensor 200 may be implemented as light (weight) and small (size) device—e. g., as a spherical-shaped device, constructed with light material where possible to make it light enough to be supported when attached to any possible surface. Further, the intelligent motion sensor 200 may incorporate an adaptable holder (shown in FIG. 2 as sensor holder 240) which may be particularly configured to allow for easy attachment to different surfaces and/or for allowing support of the intelligent motion sensor 200 when placed as freely standing device (i.e. without needing to be attached). For example, the sensor holder 240 may incorporate a flat area which may be used as support base or attachment surface, and/or the sensor holder 240 may be configured such that it may be allow for swiveling and/or rotating the intelligent motion sensor 200 in different direction (e.g., allowing 3-D swiveling/rotation). Thus, the intelligent motion sensor 200 may be attached (fixed) to particular points in a location (e.g., near doors and/or windows) and/or may be carried and placed wherever needed by the users, and may be rotated to point or focus on different directions.

In an example embodiment of the disclosure, the intelligent motion sensor 200 may comprise one or more input/output (“I/O”) interfaces. The I/O interface may comprise suitable logic, circuitry, interfaces, and/or code that may be operable to enable user interactions with the intelligent motion sensor 200 through interfaces. The I/O interface may obtain input from user(s) of the intelligent motion sensor 200 and/or provide output to the user(s). The I/O interface may support various types of inputs and/or outputs, including, for example, video, audio, and/or textual. In this regard, dedicated I/O devices and/or components, external to or integrated within the intelligent motion sensor 200, may be utilized for inputting and/or outputting data during operations of the I/O interface. Example (external or integrated) I/O devices may comprise displays, mice, keyboards, touchscreens, voice input interfaces, and other input/output interfaces or devices. In some instances, the I/O devices may provide a graphical user interface (GUI) for monitoring and/or controlling the intelligent motion sensor 200.

In some example use scenarios, the intelligent motion sensor 200 may communicate with home network managers (e.g., home network manager 210) or other devices in the home network. For example, the intelligent motion sensor 200 may communicate, to the network manager, data relating to, for example, status of the intelligent motion sensor 200, and/or other devices with which the intelligent motion sensor 200 may interact. The communications may comprise status information, predefined and/or predetermined (e.g., alarm) conditions and/or any other information that may be relevant to the operation of the intelligent motion sensor 200 and/or the other devices, and/or any other information that may be relevant to the operation of the home network. The intelligent motion sensor 200 may also receive communications from the network manager. The communications may, for example, comprise information relating to predefined and/or predetermined conditions and/or information comprising commands that may be executed on the intelligent motion sensor 200 (e.g., activate particular function therein, such as in response to particular condition).

In some example embodiments, the intelligent motion sensor 200 may incorporate a wireless range tester (not shown) that may be operable to, for example, determine whether the intelligent motion sensor 200 is within a range of a home network manager (e.g., home network manager 210) and/or other network element. In this regard, the intelligent motion sensor 200 may be operable to generate an alarm condition when the intelligent motion sensor 200 is not within a range of any home network manager (e.g., home network manager 210) and/or other network element and/or when the intelligent motion sensor 200 that, for example, was previously within the range of a (e.g., home network manager 210) and/or other network element, is now outside of that range. In an example embodiment of the disclosure, the alarm condition may active one or more alarm indicators to generate an alarm condition by, for example, generating an audible and/or a visual alarm.

In another example embodiment of the disclosure, wireless range tester may indicate whether the intelligent motion sensor 200 is in range, is in an intermediate range and/or is out of range of a home network manager. The in range indication may, for example, be associated with a condition where the intelligent motion sensor 200 may establish a direct connection with a home network manager (e.g., home network manager 210) and whether or not a direct communication is desirable (e.g., the intelligent motion sensor 200 may, for example, communicate with the home network manager utilizing other network elements although a direct communication would be possible). The in an intermediate range condition may, for example, be associated with a condition where the intelligent motion sensor 200 may not establish a direct connection with a home network manager (e.g., the home network manager 210) but may establish an indirect communication with the home network manager (e.g., through other network elements). The out of range indication may, for example be associated with a condition where the intelligent motion sensor 200 may not be able to establish either a direct and/or in direct communication with a home network manager (e.g., the home network manager 210).

In an example embodiment of the disclosure, the intelligent motion sensor 200 may indicate whether the intelligent motion sensor is in range (e.g., direct, indirect) and/or out of range through one or more audio and/or visual indicators. The indicators may be, for example, integrated with and/or external to the intelligent motion sensor 200. For example, the intelligent motion sensor 200 may comprise an external visual indicator (e.g., LED, RGB, RGBW light) that may be operable to display the status of the intelligent motion sensor 200 with respect to the range through different colors and/or illumination schemes. For example, a visual indicator may display a different color depending on the in-range status (e.g., one color may indicate that the intelligent motion sensor 200 is in a direct range, a second color may indicate that the intelligent motion sensor 200 is in indirect range and/or a third color may indicate that the intelligent motion sensor 200 is out of range). In another example, the visual indicator may blink at different frequencies, illuminate without blinking and/or be operable to display different illumination schemes depending on the in-range status of the intelligent motion sensor 200.

In another example embodiment of the disclosure, the intelligent motion sensor 200 may activate other light sources (e.g., connected to one or more other network elements).

In an example embodiment of the disclosure, the intelligent motion sensor 200 may comprise other suitable circuitry, interfaces, logic, and/or code for implementing various aspects of the present disclosure. For example, the intelligent motion sensor 200 may comprise a memory and/or a processor. The memory may store, for example, configuration data, which may comprise parameters and/or code, comprising software and/or firmware. The memory may comprise different memory technologies, including, for example, read-only memory (ROM), electrically erasable programmable ROM (EEPROM), random access memory (RAM), low latency nonvolatile memory, flash memory, solid-state drive (SSD), field-programmable gate array (FPGA), and/or other suitable electronic data storage capable of storing data, code and/or other information.

The processor may comprise suitable circuitry, interfaces, logic, and/or code that may be operable to process data, and/or control and/or manage components, operations and/or functions of the intelligent motion sensor 200, and/or tasks performed therein. In this regard, the processor may configure and/or control operations of various components and/or subsystems of the intelligent motion sensor 200, such as, for example, the memory, the communication subsystem (e.g., for communicating with, for example, the home network manager 210) by utilizing, one or more control signals. The processor may comprise a general purpose processor, which may be configured to perform or support different types of operations and/or functions (e.g., processing optical data). Alternatively, the processor may comprise one or more special purpose processor—e.g., application processors (e.g., ASIC).

In an example embodiment of the disclosure, the intelligent motion sensor 200 may be operable to receive software and/or firmware updates. For example, the intelligent motion sensor 200 may receive software and/or firmware updates from a network manager (e.g., the home network manager 210). In an example embodiment of the disclosure the software and/or hardware updates may be received, processed and/or installed automatically and/or manually. For example, the process may be completely automatic (e.g., a network manager may send an update to the intelligent motion sensor and the intelligent motion sensor may process it automatically), and/or semi-automatic (e.g., an update may be initiated by a user through, for example, a network manager, and may, for example, be processed by the intelligent motion sensor automatically).

The intelligent motion sensor 200 may comprise one or more buttons (and/or other interfaces) (not shown) either inside or outside of the intelligent motion sensor 200 for providing basic functionality to the intelligent motion sensor 200. For example, the intelligent motion sensor 200 may comprise one or more buttons that may be pressed and/or depressed sequentially and/or for a predetermined and/or preconfigured about of time to operate one or more functions of the intelligent motion sensor 200. One or more functions of the intelligent motion sensor 200 may comprise range testing (e.g., whether the intelligent motion sensor is within a home network), connecting to a home network (e.g., paring between an intelligent motion sensor and a home network through, for example, a network manager) and/or temper prevention.

In an example embodiment of the disclosure the one or more buttons may be located inside of the intelligent motion sensor 200, such that, for example, when the intelligent motion sensor 200 is tampered with (e.g., casing is opened) the button may, for example, become depressed. In this regard, the intelligent motion sensor 200 may generate a tamper alarm condition. The condition may be communicated on the home network (e.g., home network 100), to other devices and/or a home network manager (e.g., home network manager 210).

In an example embodiment of the disclosure, the operation of the intelligent motion sensor 200 may be initiated by pre-defined and/or preconfigured condition that the intelligent motion sensor 200 may be operable to determine and/or receive an indication thereof. For example, the intelligent motion sensor 200 may be operable to determine and/or receive an indication of a condition that may, for example, be determinable through, for example, a sensor. In this regard, the intelligent motion sensor 200 may comprise one or more sensor and/or may receive input from one or more sensors and/or sensory devices. For example, the intelligent motion sensor 200 may generate a status and/or an alarm message in response to an input from a sensor. In this regard, the intelligent motion sensor may receive an indication of, for example, an inside and/or outside temperature from a temperature sensor. The intelligent motion sensor 200 may generate a status and/or an alarm message (e.g., temperature exceeds a predefined limit and may be indicative of overheating, fire, air conditioning malfunction, etc.) in response to the sensory reading (e.g., temperature, rain conditions, time of day).

In some example embodiments of the disclosure, the intelligent motion sensor 200 may be designed, implemented, and/or configured to provide ‘intelligent’ services and/or functions, which may be particularly configured to be based on or incorporate use of motion detection. The ‘intelligence’ in these services and/or functions may relate to, for example, the ability to track and/or recognize (or identify) persons, and as such these functions or services may be adaptively configured based on that knowledge. For example, as described above, in one example use scenario, the intelligent motion sensor 200 may be used to track and/or monitor activities of particular persons (e.g., housekeepers) in a particular location (e.g., residence), based on particular criteria (e.g., assessing quality of work done thereby, such as by monitoring the amount of time spent in each room).

In another example use scenario, the intelligent motion sensor 200 may be utilized to provide motion detection based ‘intelligent’ control of lighting fixtures. For example, the intelligent motion sensor 200 may determine based on motion detection (and processing of information generated therefrom, particularly optical based data) when all persons leave particular location or are all asleep (e.g., a room in a residence). Based on that information, as well as ambient climate measurements, the intelligent motion sensor 200 may turn off any light fixtures that may be on in that location. Similarly, when the intelligent motion sensor 200 determines that one or more persons enter a location, the intelligent motion sensor 200 may turn on one or more of the light fixtures available in that location. The adjustments may be applied directly by the intelligent motion sensor 200 (e.g., using direct links to climate related elements) or the adjustments may be provided to the home network manager 210, to handle applying these adjustments.

In another example use scenario, the intelligent motion sensor 200 may be utilized to provide motion detection based ‘intelligent’ climate control services. For example, the intelligent motion sensor 200 may determine based on motion detection (and processing of information generated therefrom, particularly optical based data) number of persons, as well as additional information related thereto—e.g., age, weight, etc., in a particular location or a space therein (e.g., particular room in a residence). Based on that information, as well as ambient climate measurements, which may be obtained directly by the intelligent motion sensor 200 and/or through other home network elements (e.g., environmental sensory devices 120h), the intelligent motion sensor 200 may determine suitable climate adjustments (e.g., adjustment to air conditioning, fans, etc.) to ensure that the climate environment remains pleasant. The adjustments may be applied directly by the intelligent motion sensor 200 (e.g., using direct links to climate related elements) or the adjustments may be provided to the home network manager 210, to handle applying these adjustments.

In another example use scenario, the intelligent motion sensor 200 may be utilized to provide motion detection based ‘intelligent’ home security services. For example, the intelligent motion sensor 200 may determine, based on motion detection (and processing of information generated therefrom, particularly optical based data) when all persons leave a particular location (e.g., all residents leave, and as such no one is home). Based on that information, the intelligent motion sensor 200 may activate any one or more home security systems (if available). In some instances, the intelligent motion sensor 200 may, before activating the home security systems, send messages to the users asking if they'd like to activate such systems (and/or to specify which systems to activate). Alternatively, the intelligent motion sensor 200 may be configured to proceed with such activation based on preset criteria (e.g., if no one is home for more than 15 minutes). The activation may be applied directly by the intelligent motion sensor 200 (e.g., using direct links to the home security systems); or the activation may be done through the home network manager 210, based on messages from the intelligent motion sensor 200.

In some instances, the intelligent motion sensor 200 may be utilized to monitor and/or track actions or habits of particular users, such as for use in configuring and/or controlling adaptive ‘intelligent’ services or functions provided by (or using information obtained via) the intelligent motion sensor 200. For example, the intelligent motion sensor 200 may monitor and/or track, based on motion detection (and processing of information generated therefrom, particularly optical based data), various persons associated with leave a particular location (e.g., all residents in a particular residence). Based on that information, the intelligent motion sensor 200 may ‘learn’ habits of each persons (e.g., meal times, study times, sleep times, etc.) as well as individual preferences (e.g., preferred lighting conditions, climate conditions, etc.). Such information may be used to further improve services provided by the intelligent motion sensor 200. For example, the intelligent motion sensor 200 may learn when to turn off lights in particular rooms if it learns that the person associated with that space (e.g., a child in his/her bedroom) goes to sleep at particular, regular time. In some instances, the intelligent motion sensor 200 may be configured to monitor and/or track the variation in persons' activities, such as to enable adjusting services or functions provided by the intelligent motion sensor 200 based on these variations. For example, the intelligent motion sensor 200 may monitor the quality (i.e. degree of deepness) of sleep of particular users, such as throughout the night. That information may be used, for example, to adjust the degree of alarm needed to wake those users (e.g., the deeper the users are asleep, the louder any alarm, whether security related alarms or wakeup alarms, would be set).

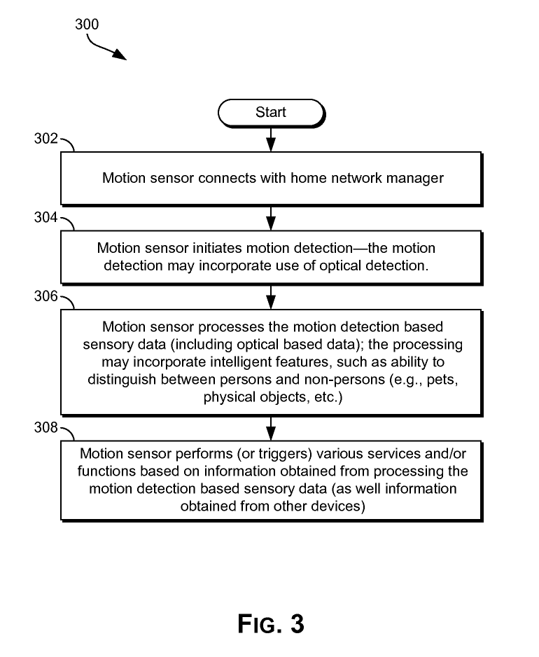

FIG. 3 illustrates an example flow chart of a method for an example process of operation of one or more intelligent motion sensors. Referring to FIG. 3, there is shown a flow chart 300 comprising a plurality of example steps.

In example step 302, an intelligent motion sensor (e.g., the intelligent motion sensor 200 as depicted in and/or described with respect to FIG. 2) may connect with a home network manager (e.g., the home network manager 210 as depicted in and/or described with respect to FIG. 2). The connection may comprise a communication link (e.g., the communication link 220 as depicted in and/or described with respect to FIG. 2), such as, for example, a Z-Wave link. The connection may comprise one or more types of wireless and/or wired connections. The connecting may, in some instances, comprise determining whether the intelligent motion sensor is within range of the home network manager. In this regard, the intelligent motion sensor may incorporate a wireless range tester for determining whether the intelligent motion sensor is within a range of a home network manager as described with respect to FIG. 2, for example.

In example step 304, the intelligent motion sensor may initiate motion detection operation in the home network. In this regard, the motion detection may incorporate use of advanced motion detection techniques, such optical based detection, as describe with respect to FIG. 2 for example.

In example step 306, the intelligent motion sensor may process the motion detection based sensory data (including optical based data); the processing may incorporate intelligent features, such as ability to distinguish between persons and non-persons (e.g., pets, physical objects, etc.). The processing may be done completely and directly by the intelligent motion sensor; alternatively, the intelligent motion sensor may offload at least some of the processing to other devices).

In example step 308, the intelligent motion sensor may perform (or trigger) various services and/or functions based on information obtained from processing the motion detection based sensory data (as well information obtained from other devices—e.g., climate related information obtained from environmental sensor home elements). Examples of services and/or functions that may be performed or triggered based on information obtained from the motion detection may comprise security related functions, climate relate functions, lighting related functions, and the like, as described with respect to FIG. 2 for example. The disclosure is not limited, however, to any particular functions and/or services (or types thereof), and may be applied in similar manner to any conceivable function or service that may be associated with or relate to information that may be obtained by the motion detection provide by the intelligent motion sensor.

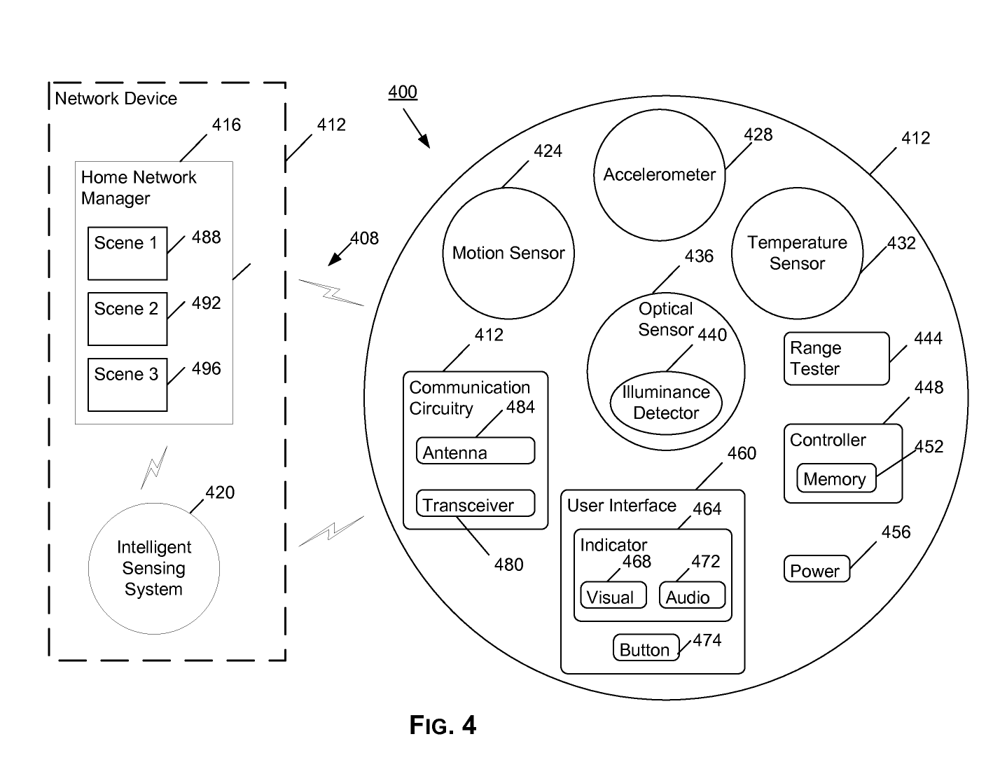

FIG. 4 illustrates an example intelligent sensing control system or control system 400 for use with an intelligent sensing device 404, similar to the intelligent sensing device 200 of FIG. 2 and the intelligent motion sensor 120l of FIG. 1, in a home network 408, similar to the home network 100 of FIG. 1, to communicate with a network device 412 in the network 408, such as a home network manager 416, similar to the home network manager 110 of FIG. 1 and the home network manager 210 of FIG. 2, and a second intelligent sensing device 420, also similar to the intelligent sensing device 200 of FIG. 2. Other network devices, such as, the plurality of home network elements 120a-120n, may also be used as the network device 412, depending on applications.

The intelligent sensing device 404 may include a plurality of modules and/or sensors, similar to the sensor 250 of FIG. 2, including a motion sensor 424, an accelerometer 428, a temperature sensor 432, and an optical sensor 436. In the embodiment shown, the optical sensor 436 may also include an optical detector or an illuminance detector 440. The intelligent sensing device 404 may also include a range tester 444 and a processor or a controller 448, which may also include an embedded memory 452. Although the memory 452 is shown as an embedded memory, the memory 452 may also be external to the controller 448.

The intelligent sensing device 404 may use the range tester 444 to determine if the intelligent sensing device 404 is within a range of the home network manager 416. If the intelligent sensing device 404 or the range tester 444 determines that the intelligent sensing device 404 is within a range of the home network manager 416, the home network manager 416 may be associated with the intelligent sensing device 404. In some embodiments, the intelligent sensing device 404 may be included in the network 408, which may be wireless or wired, through association with the home network manager 416 through the intelligent sensing device 420, or other network devices, similar to 120a-120n of FIG. 1.

As shown, the intelligent sensing device 404 is a battery-powered device. In some embodiments, the battery may be a rechargeable battery, or power source 456. The power source 456 may have predetermined shelf life, for example, approximately 2 years, for example, at factory default settings. In some embodiments, the home network manager 416 may be configured to display a current battery level of the power source 456. For example, the home network manager 416 may display a special battery icon indicative of the current battery level. When the current battery level falls below a particular or predetermined threshold, the special battery icon may change color to indicate that the power source 456 needs replacement.

In the embodiment shown, the temperature sensor 432 may determine or monitor temperature conditions proximate the intelligent sensing device 404 and/or the intelligent sensing device 420, depending on applications. For example, the intelligent sensing device 404 may operate one or more structural fixtures such as the windows/window blinds 120d, of FIG. 1. In some embodiments, in response to the monitored temperature exceeding a predetermined temperature threshold, and/or a predetermined temperature threshold within one of a plurality of temperature ranges, the controller 448 may generate an indication. In response to receiving the indication, a user interface 460 may be activated. For example, the user interface 460 may activate an indicator 464 visually, for example, via a visual indicator 468, and/or audibly, for example, via an audio indicator 472. In some embodiments, the visual indicator 468 may a multi-color LED, and may arrange the LED to emit different colors depending on which of a plurality of temperature ranges that the determined temperature falls within. For example, when the monitored temperature is 63° F., the LED may emit light blue color. When the monitored temperature is 70° F., the LED may turn green. When the monitored temperature exceeds 84° F., the LED may turn orange. In other embodiments, a change in the monitored temperature may result the LED flashing a particular color, and activate a ventilation unit or an air-conditioner unit (not shown).

In this regard, when the intelligent sensing device 404 is determining an operating range with the range tester 444 with respect to the home network manager 416, the visual indicator 468 may generate a visual indication, such as, for example, slowly blinking and/or of one color, to indicate an appropriate operating range, and may generate a different visual indication, such as, for example, rapidly blinking and/or of another color, to indicate an inappropriate operating range, for example, when the intelligent sensing device 404 is outside of the operating range of the home network manager 416. In this regard, the user interface 460 also includes a range testing button or button 474 allowing a user to test the operating range as discussed above.

In the embodiment shown, the illuminance detector 440 may determine a luminance proximate the intelligent sensing device 404. Although the illuminance detector 440 is shown as internal to the optical sensor 436, the illuminance detector 440 may also be external to the optical sensor 436, or to the intelligent sensing device 404. The measured luminance may then be used to control lighting fixtures, such as, lighting fixtures 120e of FIG. 1, or other light emitting devices (e.g., desk lamp) nearby, such as to increase or decrease the luminance. Particularly, for example, when the illuminance detector 440 detects that the monitored luminance falls below a predetermined luminance level, the illuminance detector 440 may trigger the controller 448 to generate a luminance indication. In response to receiving the luminance indication, a communication circuitry 476 may communicate the luminance indication to activate a nearby network device, such as, for example, a desk lamp, via a transceiver 480 and an antenna 484. In this regard, the communication interface 460 transmits through the transceiver 480 and/or the antenna 484 data indicative of the indication to the home network manager 416, and/or the network device 412.

In the embodiment shown, the motion sensor 424 may detect a predetermined level of vibrations, for example, earthquake, and trigger the controller 448 to generate a warning indication. In some embodiments, if the motion sensor 424 detects any motion of an object within a detection range, the motion sensor 424 may trigger the optical sensor 436 to record an image of the object, and activate the transceiver 480 to communicate data of the image to a predetermined network device 412, such as, for example, the home network manager 416, or the mobile phone 120k of FIG. 1. In this way, an owner of the system 400, or of the mobile phone 120k, may view the recorded object, and determine a course of action with respect to the object and/or the motion. In another example, the motion sensor 424 may also facially recognize the object.

In this regard, the motion sensor 424 and/or the controller may keep track of a number of the recognized objects. For example, if the controller 448 determines that the number of recognized objects detected by the motion sensor 424 at a particular time does not match with a predetermined number, or with a number previously determined or recorded in the memory 452, the controller 448 may generate an indication for display at the indicator 464, and/or transmit the indication to the network device 412, for example, the network manager 416, or the mobile phone 120k of FIG. 1. In this way, the intelligent sensing device 404 may keep track of the number of objects that has entered a particular area, and/or left the particular area.

To save consumable energy, the intelligent sensing device 404, through the motion sensor 424, may also activate nearby lighting fixtures, such as, lighting fixtures 120e of FIG. 1, when the motion sensor 424 detects some motions near the intelligent sensing device 404 and the controller 448 or the illuminance detector 440 also determines that lighting near the intelligent sensing device 404 is below a predetermined luminance, the controller 448 may activate nearby lighting fixtures. In this way, power consumption by the lighting fixtures, lighting detected, and temperatures measured in a particular area may be precisely monitored. In some embodiments, the motion sensor 424 has a set of predefined detection sensitivities. In some embodiment, the set of detection sensitivities is user-adjustable, based on applications and an area that the intelligent sensing device 404 is installed.

In some embodiments, the motion sensor 424 may also be used as a security monitor. For example, the motion sensor 424 and/or the controller 448 may be configured to provide a warning indication when an object or predetermined recognized object enters an area. Depending on needs and application, the home network manager 416 may be configured to activate one or more scenes 488, 492, 496, based on indications received from the intelligent sensing device 404. For example, in scene 488, the motion sensor 424 may be configured to wait or delay for a predetermined period of time before turning off a desk lamp, even though the luminance detected by the illuminance detector 440 falls below a predetermined level. In scene 492, the home network manager 416 may be configured to turn off lighting fixtures at a predetermined time of day followed by activating the motion sensor 424. In scene 496, for example, the home network manager 416 may be configured to call a predetermined telephone number and/or send an email to a predetermined address when the accelerometer 428 detects a vibration indicative of tampering and/or an earthquake. In other embodiments, the scene 496 may also activate the audio indicator 472 to generate an alarm signal to indicate that the intelligent sensing device 404 has been tampered with.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for an intelligent motion sensor.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. An intelligent sensing device comprising:
a temperature sensor configured to detect a temperature proximate the intelligent sensing device;
a motion sensor configured to detect a presence of one or more objects;
a controller configured to receive the temperature and the presence of the one or more object, to determine if the received temperature exceeds a temperature threshold, and to track a number of the one or more objects; and
an indicator configured to generate an alarm responsive to one of 1) the received temperature exceeding the temperature threshold and 2) the number not matching a number threshold.

2. An intelligent sensing device of claim 1, further comprising an optical sensor configured to measure light intensity near the intelligent sensing device, and wherein said controller is further configured to activate a network device in response to the measure light intensity exceeding a threshold.

3. An intelligent sensing device of claim 1, further comprising an accelerometer configured to detect a vibration of the intelligent sensing device, and to detect a tampering of the intelligent sensing device.

4. An intelligent sensing device of claim 1, further comprising a wireless transceiver configured to include the intelligent sensing device in a wireless network, and to communicate with a second wireless device in the wireless network after the intelligent sensing device has been included in the wireless network.

5. An intelligent sensing device of claim 4, wherein the second wireless device comprises a network manager configured provide the wireless network, and to manage the intelligent sensing device wirelessly within a range.

6. An intelligent sensing device of claim 4, wherein the second wireless device comprises a second intelligent sensing device included in the wireless network.

7. An intelligent sensing device of claim 1, wherein the indicator comprises an light-emitting diode (LED) configured to emit light of one or more colors responsive to different temperature ranges detected by the temperature sensor.

8. An intelligent sensing device of claim 1, wherein the motion sensor is further configured to facially recognize the one or more objects, and to continually track the recognized one or more objects.

9. A control system for use with a sensing device in a wireless network, the control system comprising:
a control device configured to perform a predefined action;
an intelligent sensing device comprising:
a temperature sensor configured to detect a temperature proximate the intelligent sensing device;
a motion sensor configured to detect a presence of one or more objects;
a controller configured to receive the temperature and the presence of the one or more object, to determine if the received temperature exceeds a temperature threshold, and to track a number of the one or more objects; and
an indicator configured to generate an indication responsive to one of 1) the received temperature exceeding the temperature threshold and 2) the number not matching a number threshold;
a transceiver configured to communicate the indication; and
a network manager, being remote from the intelligent sensing device and the control device, wirelessly coupled to the intelligent sensing device and the control device through the wireless network, and configured to receive the indication from the intelligent sensing device, and, in response to having received the indication, to perform the predefined action.

10. A control system of claim 9, and wherein the network manager is further configured to determine if a predefined condition is met, and, in response to the predefined condition having been met, and the indication having been received, to carry out the predefined action.

11. A control system of claim 10, and wherein the predefined condition comprises at least one of a time of day, a day of a week, and a lighting condition within a vicinity of the intelligent sensing device.

12. A control system of claim 9, and wherein the control device comprises at least one of a roller blind, a temperature control, a burglary alarm, and a second intelligent sensing device different and remote from the network manager.

13. A control system of claim 9, and wherein the intelligent sensing device further comprises an optical sensor configured to measure light intensity near the intelligent sensing device.

14. A control system of claim 9, and wherein the intelligent sensing device further comprises an accelerometer configured to detect a vibration of the intelligent sensing device, and to detect a tampering of the intelligent sensing device.

15. A control system of claim 9, and wherein the intelligent sensing device further comprises a wireless transceiver configured to include the intelligent sensing device in the wireless network, and to communicate with the control device in the wireless network after the intelligent sensing device has been included in the wireless network.

16. A control system of claim 9, and wherein the indicator comprises an light-emitting diode (LED) configured to emit light of one or more colors responsive to different temperature ranges detected by the temperature sensor.

17. A control system of claim 9, and wherein the motion sensor is further configured to facially recognize the one or more objects, and to continually track the recognized one or more objects.

18. A method of controlling a network device operable to perform a function in a network via a) an intelligent sensing device, and being remote from the network device, and b) a network manager operable to communicate with the network device and the intelligent sensing device, the method comprising:
detecting at the intelligent sensing device a temperature proximate the intelligent sensing device;
detecting at the intelligent sensing device a presence of one or more objects;
determining if the temperature exceeds a temperature threshold;
tracking a number of the one or more objects; and
generating an indication responsive to one of 1) the temperature exceeding the temperature threshold and 2) the number not matching a number threshold.

19. A method of claim 18, and further comprising determining if a predefined condition is met; and, in response to the predefined condition having been met, and the indication having been received, performing the predefined function.

20. A method of claim 18, and wherein the predefined condition comprises at least one of a time of day, a day of a week, and a lighting condition within a vicinity of the intelligent sensing device.
